(19) United States
(12) Patent Application Publication
(10) Pub. No.: US 2006/0005135 A1
(43) Pub. Date: Jan. 5, 2006

(54) Method for quantifying a visual media file size in an electronic device, an electronic device utilizing the method and a software program for implementing the method

(75) Inventor: Asko Vetelainen, Jaali (FI)

Correspondence Address: HARRINGTON & SMITH, LLP, 4 RESEARCH DRIVE, SHELTON, CT, 06484-6212, US

(73) Assignee: Nokia Corporation

(21) Appl. No.: 10/881,379

(22) Filed: Jun. 30, 2004

(51) Int. Cl. G11B 27/00

(52) U.S. Cl. 715/723

(57) ABSTRACT

The invention relates to a method for quantifying and showing the file size of a selected part of a visual media file, which selected part of the media file is shown on a display of an electronic device. The invention further relates to a computer program product utilized with the method and an electronic device utilizing the method.

### FIELD OF THE INVENTION

The invention relates to a method for quantifying and showing the file size of a selected visual media file in an electronic device. The invention also relates to an electronic device utilizing the method and a software program implementing the method in an electronic device.

### BACKGROUND OF THE INVENTION

Today a user of an electronic device can utilize various applications in his or her device. These electronic devices have become smaller and also mobile. Some examples of these devices are mobile phones and PDAs (Personal Digital Assistant). A user of them can save for example visual media records as text, pictures, video clips or multimedia files in his or her device. However, in some user applications the file size of this kind of visual media can have some limitations. For example the memory of the electronic device can be limited in size. If the user tries to save a visual media record with substantial file size, it is possible, that the file size exceeds allowed file size limits. The only way to overcome this problem is to edit the visual media record in some way and make a new attempt. If the file size after the edition is in allowable limits, the visual media file can be saved in the memory of the electronic device.

Also the mobile cellular terminals are capable to be utilized in various ways nowadays. In some applications the user can save pictures and video clips in them. The memory capacity of these mobile terminals has increased considerably. So their memory capacity is big enough for saving rather big media files. However, if the user wants to send pictures, video clips or multimedia files to one or several other people new problems arise. The first problem is that if the file has a size of Megabytes, the capacity of the serving cellular network can become critical. This can for example happen, if several users try to send messages which include considerable media files at the same time.

One example of a situation of this kind is a PDI (Personal Data Interchange) information transmission. One possible way to carry out a PDI is to change so-called vCards. A vCard can also comprise a picture of the vCard owner. We can easily imagine a situation in a meeting where several people are gathered together. In some moment they want to change their vCards between each other. If the file size of the picture in a vCard were large, the serving capacity of the cellular network could be exceeded.

On the other hand, in several packet switched networks the network users are charged based on transferred data. So if a user of the network sends a message including a media file of a size of Megabytes, it costs to the user much more than a media file of a size of kilobytes.

Because of above-mentioned reasons for example in a vCard system it is advantageous to limit the size of a picture file for example to 5 kilobytes. So when a user of the vCard system wants to save his or her photo in a picture file in his electronic device, he or she can use an application where it is recommended that the picture file size should not be larger than 5 kilobytes. In editing and saving work the user can utilize several prior art photo editing software, for example Adobe Photo Shop™. With it the user can select a certain part or an area from a picture with a selecting tool, which selected area is then saved in the electronic device. One example of possible selecting tools is a square, which can be dragged around a wanted portion of the original picture. Dimensions of the selected area can be shown for example as pixels, centimeters or inches. However, this type of representation does not indicate the actual file size of the selected picture area. Only after executed copy or cut command the user can see the file size.

Some other picture editing software of the prior art do not show the picture file size at all. When using such software, the user tries to save the created picture record in the memory of the electronic device after made selection. As noted earlier the user cannot know before a saving attempt, if the file size of the picture is over some predetermined size or not. So the user must make an attempt to save the picture record. If the attempt is successful, the file size of the edited picture is less than the predetermined limit. On the other hand, if the attempt is unsuccessful the file size is larger than said file size limit. In this situation the user must start from the first beginning again; make a new selection with different picture borders and make a new attempt to save the new selection. This undesired situation can repeat several times before it succeeds.

Another example of a user solution where picture files can be limited in size is so-called Presence application. In Presence application a user of an electronic device can by a special message show to other users what he or she is doing just now. One possible way of doing this is to use a descriptive picture included in this message. To avoid too big picture files to be created and transferred the picture file size can be limited to for example 4 kilobytes.

As noted above the cellular devices of the prior art have also a capability to take and save video clips. Saved video clips can be of considerable size both in time and file size. In this context the user of the device has to decide how long the video clip can be if he or she for example wants to send the clip through a cellular network. As noted above the user of the cellular network pays transmission costs based on the file size of the sent message. Basically the longer the clip the bigger is its file size included in the message. On the other hand also the picture resolution has an effect on the file size of the video clip. So it would be of value to the user of the device to know what the file size of the video clip really is. If the video clip can be shortened or sent with a poorer resolution, it costs less to the user of the device when the video clip is actually sent.

### SUMMARY OF THE INVENTION

An object of the invention is to provide a new selecting and editing method for visual media records, such as pictures, videos or multimedia, where a user of an electronic device can know without any saving attempt of the visual record what the actual file size is.

The objects of the invention are achieved by a method and a device arrangement, where editing some visual media on a display of an electronic device with an editing tool causes the actual file size of the edited visual media record to be shown to the user of the electronic device. This is done before the user conceivably saves the edited visual media in the electronic device.

An advantage of the invention is that the user knows, without any saving attempt, that the actual visual media file size is below some defined file size limit.

Another advantage of the invention is that the user can see the actual size of the file during editing operation of the visual media; so the user knows already during the editing operation that the processed visual media record is of suitable size for user's present application.

Yet another advantage of the invention is that a compression method used can be taken into the consideration when the record size is calculated.

The idea of the invention is basically as follows: Counter software suitable for file size counting of visual media record is saved in an electronic device. When a user of the electronic device uses some picture, video or multimedia editing software, which can be called as media editor, and especially its editing tool, the counter software according to the invention calculates the definitive file size of the edited visual media record. In the calculation the counter software advantageously takes also a compression method conceivably used in the editing process into the consideration. The present invention allows the user to see during selection or editing process continuously how big the visual media record would be if the present edited visual media record would be accepted for use.

### BRIEF DESCRIPTION OF THE DRAWINGS

The invention is described in detail below. Reference is made to the accompanying drawings in which

FIG. 1 shows a schematic representation of a cellular terminal where the method according to the invention is utilized in connection with a picture;

FIG. 2 shows as an exemplary a flow chart including main stages of the method according to the invention; and

FIG. 3 shows an exemplary cellular terminal capable of utilizing the invention.

### DETAILED DESCRIPTION

Next is depicted, as an example, how the present invention can be utilized when the visual media file consists of a picture file.

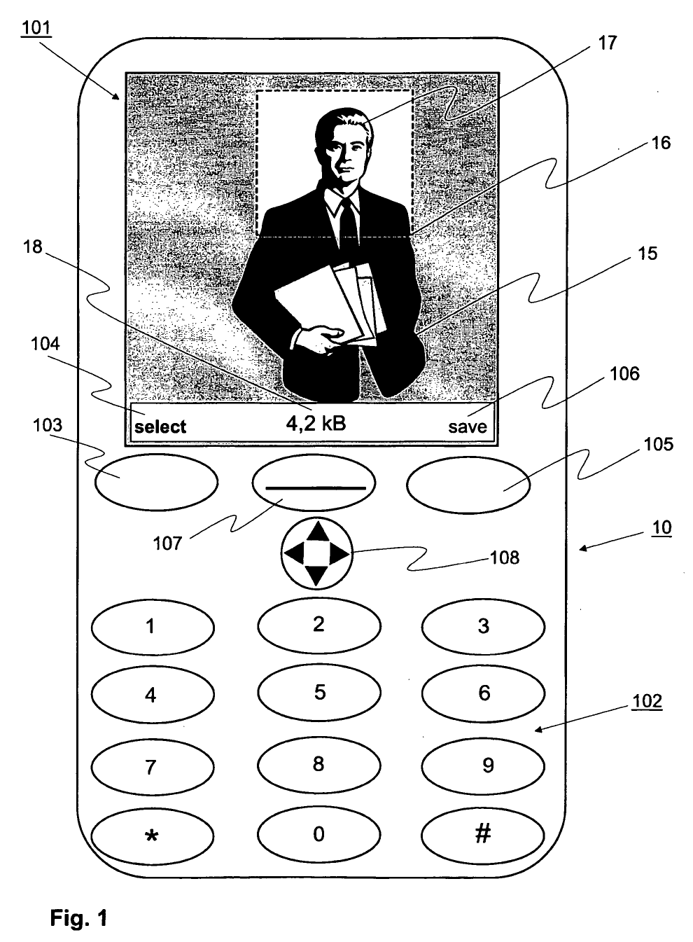

FIG. 1 depicts an example of a mobile terminal 10 used in a cellular network. The mobile terminal 10 itself can consist of parts according to the prior art. It is evident to a man skilled in the art that the present invention can be implemented also in various other electronic devices for example in PDA or in PC.

The exemplary mobile terminal 10 in FIG. 1 comprises various functional components of a conventional cellular terminal: an alphanumerical keyboard 102, a four-way key 108, one or several programmable keys 103, 105 and 107 and a display unit 101. The exemplary functions of programmable keys 103 and 105 are shown on the display 101 as selectable options: “select” reference 104, and “save” reference 106. Also an exemplary picture of a man 15 is shown on the display 101.

The mobile terminal 10 can also comprise optical and electronic means for taking and saving still pictures or video clips (not shown in FIG. 1).

In the example of FIG. 1 a user of the mobile terminal 10 has launched in the terminal 10 a picture editing software of the prior art. The reference 104 “select” is high lighted on the display 101 by bolding because the user also utilizes a selection tool of the editing software and makes a selection 16 by the selection tool of the picture editing software. One well-known way to do the selection is to drag an expanding square above the original picture. The final square can be of any size and located in any place compared to the original picture. This method is utilized in the example of FIG. 1.

As can be seen, the selection 16 made is only a small part of the original picture 15. It consists mainly a face portrait of a man, which the user of the mobile terminal wants to save in the mobile terminal 10 in some predetermined format. The saved picture is advantageously compressed by some compression method of the prior art. Some well-known compression methods for pictures are GIF (Graphics Interchange Format), TIFF (Tag Image File Format) and JPEG (Joint Photographic Experts Group). The file size of the picture 16, which the user wants to save, can have an upper limit of few kilobytes because of the user application utilized or the user itself wants to limit the file size for some reason.

In FIG. 1 by a reference 18 is depicted the file size of the selected picture area 16 calculated according to the invention. It can be seen that in example of FIG. 1 the file size of the selected picture area 16 is 4.2 kilobytes. This file size could have been calculated with or without a picture compression method of prior art. If we then assume that the user wants to limit the file size maximum to 5 kilobytes for picture records, so in the example of FIG. 1 the user has reached the goal set.

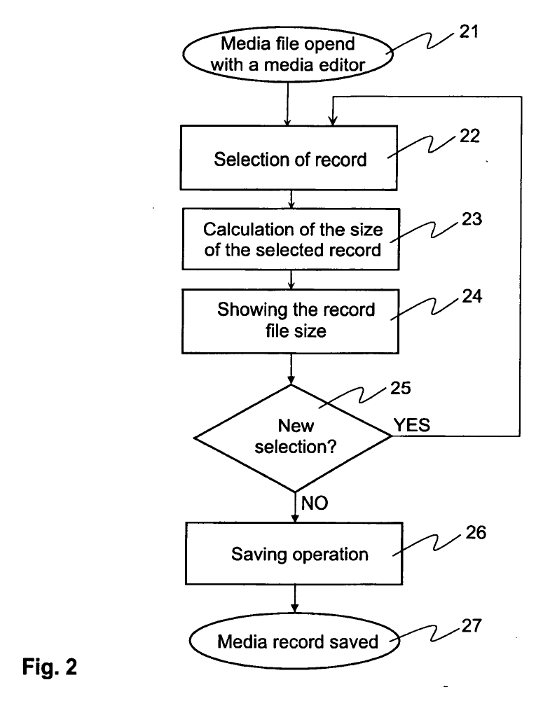

FIG. 2 illustrates as an exemplary flow chart the main stages of the present invention utilized in a visual media file size quantification. Reference is also made to FIG. 1, which deals with a picture editing example where a selection square is utilized, to clarify the description. In phase 21 a user of an electronic device, which can be for example a mobile terminal of FIG. 1, opens a visual media file in the electronic device with a media editor. This media editor can be for example any picture editing software of the prior art. The only requirement is that it must comprise tools for making a selection or cutting a part from an original picture.

In phase 22 the user makes a selection 16 from the original picture 15 using a suitable selection tool of the media editor. The selected picture area 16 can be compressed using some prior art compression method during or after the selection. When the selection is completed the user can advantageously save the selection as a visual media file, i.e. a record, in the memory of the electronic device 10.

In an advantageous embodiment of the invention the file size calculation can be executed already during the selection operation in phase 22. Alternatively in another embodiment of the invention the file size calculation is performed in a separate phase 23 when the user has given a mark or it is evident that the selection or editing is complete.

In phase 24 the calculated visual media record size 18 is advantageously shown on the display 101 of the electronic device 10 to the user. The shown record size can either be in allowable limits or outside them. If the record size is bigger than allowable or recommended value, the user itself or the utilized application makes a decision in phase 25, i.e. YES option, which redirects the process back to phase 22.

However, despite the fact that the visual media record size is correct there can be situations where the user wants to modify or change the selection made. To fulfill this need there is always an optional opportunity for the user in decision phase 25 to decide to make a new selection. Also in this case the process returns again to phase 22 where a completely new selection is possible.

If the process has returned to phase 22, at least two possible alternatives exist. The first one is that the user makes a completely new selection from the first beginning. A second possible alternative is that the user does not want to change the size of the earlier selected picture but only to move the selection square a little bit to some direction. Also this movement, without size change, can affect the file size of the selected picture area. In both alternatives the file size of the new picture selection is once again calculated in phase 23 and shown in phase 24.

If the user has decided in phase 25 that he or she is satisfied with the selection or editing, the answer alternative “NO”, the process continues advantageously to phase 26 where the selection, for example selected picture area 16, is saved as a record in the memory of the electronic device 10. The process according to the invention ends up to phase 27 where the new smaller visual media record is saved in the electronic device 10.

In the description above an area selection from a bigger picture was used as an example on how to utilize the method according to the present invention. If we utilize the inventive method with video clips or multimedia files, the word selection gets broader meaning. In this context the word selection can mean that the user selects or cuts a certain length of a video clip or a multimedia file. Another possible meaning can be that the user modifies the picture resolution utilized in the visual media. In both cases the user wants to reduce the size of the final visual media record.

The steps according to the invention as depicted in FIG. 2 are advantageously implemented by a software application, i.e. media file size quantifying software according to the invention, which is saved in the electronic device.

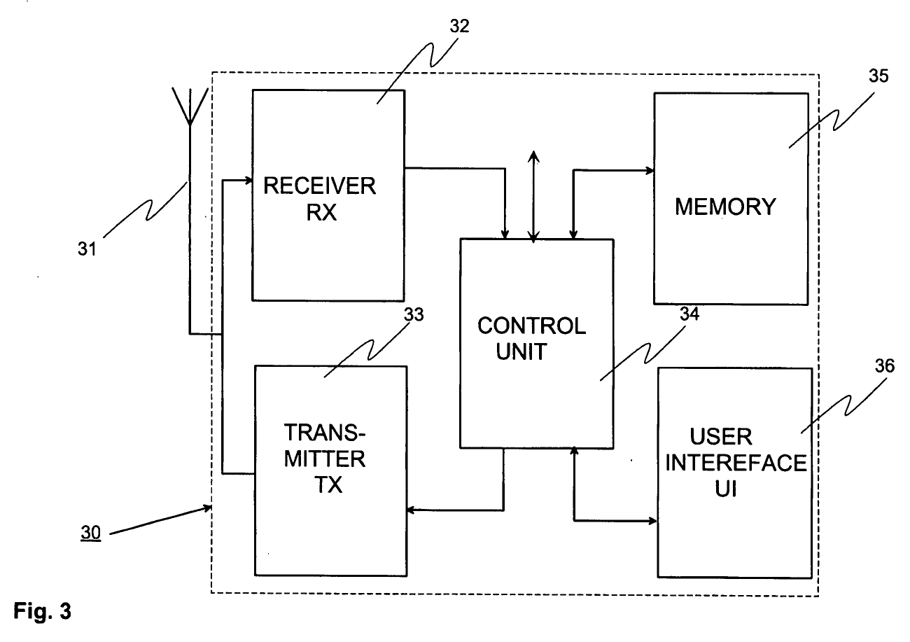

FIG. 3 shows as an example the main components of a wireless cellular terminal 30 utilizing the method according to the invention. The cellular terminal 30 shown in FIG. 3 uses an antenna 31 in transmitting and receiving from the serving cellular network. The reference numeral 32 represents those means that form the receiver RX, with which the wireless terminal 30 receives messages from the cellular network. The receiver RX comprises prior art means for all received messages or signals.

The reference numeral 33 represents those means which form the transmitter TX of the wireless cellular terminal 30. The transmitter means 33 perform for the transmitted signal all signal processing procedures, which are required during operation in the cellular network.

With regard to utilizing the invention an essential operational unit in the cellular terminal is the control unit 34. It controls the operation of all the main parts of the cellular terminal 30. It controls both reception and transmission. And it is also used to control both the user interface UI 36 of the terminal device, which includes a display (not shown in FIG. 3), and the memory 35 of the terminal device whereto a visual media file size calculating software according to the invention has been saved.

In the cellular terminal 30 according to the invention a media editor, for example imaging software of the prior art is executed in the control unit 34. The media editor also comprises a selection tool by which the user can select a desired part from a bigger picture, shorten or lengthen a video clip length or modify the picture resolution. The visual media file size quantifying software according to the invention is linked to the media editor so that the file size of a made selection or edition is shown on the display of the cellular terminal.

Some advantageous embodiments according to the invention were described above. The invention is not limited to the embodiments described. The inventional idea can be applied in numerous ways within the scope defined by the claims attached hereto.

1. A method for quantifying a visual media file in an electronic device the method comprising
a phase for opening a visual media file with a media editor software in the electronic device,
a phase for selecting on a display of the electronic device a part of a visual media file by a selecting tool of the media editor software,
a phase for calculating the file size of the selected visual media record, and
a phase for showing the calculated file size of said selected visual media record on the display of the electronic device.

2. The method according to claim 1 which further comprises a phase for saving the selected visual media record in the electronic device.

3. The method according to claim 2 wherein the selection is saved in the electronic device if the calculated visual media record size is below a predetermined file size.

4. The method according to claim 1 wherein the calculation of the file size of said selected visual media record is accomplished within said selection.

5. The method according to claim 1 wherein the calculation of the file size of the selected visual media record is accomplished after said selection.

6. The method according to claim 1 wherein the calculation of the file size of the selected visual media record is accomplished with said selected visual media record uncompressed.

7. The method according to claim 1 wherein the calculation of the file size of the selected visual media record is accomplished after said selected visual media record is compressed.

8. The method according to claim 7 wherein the compression method utilized is one of the following: GIF, TIFF or JPEG.

9. The method according to claim 1 wherein the visual media file is a picture file and the editor software is imaging software.

10. The method according to claim 9 where the picture file is utilized in connection with a vCard application or a Presence application.

11. A computer program product comprising:
A computer usable medium having computer readable code means embodied therein for causing a computer included in an electronic device to quantify the file size of a selected visual media record on a display of the electronic device, the computer readable code means in the computer program product comprising:
a computer readable code means for calculating the file size of a selected visual media record shown on the display of the electronic device, and
a computer readable code means for showing the calculation result on the display of the electronic device.

12. The computer program product according to claim 11 further comprising a computer readable code means for saving the selected visual media record in the electronic device, if its calculated file size is below a predetermined file size.

13. The computer program product according to claim 11 wherein the computer readable code means for calculating the file size of a selected visual media record are arranged to make said calculation within said selection.

14. The computer program product according to claim 11 wherein the computer readable code means for calculating the file size of a selected visual media record are arranged to make said calculation after said selection.

15. The computer program product according to claim 11 wherein the computer readable code means for calculating the file size of a selected visual media record are arranged to make said calculation after said visual media record is compressed.

16. The computer program product according to claim 11 wherein the visual media record is a picture file.

17. The computer program product according to claim 16 wherein the computer readable code means for calculating the file size of a selected picture area are arranged to be utilized with a vCard application or a Presence application.

18. An electronic device comprising
a control unit capable of executing commands of a media editor software,
a memory for saving the media editor software and visual media records processed with said media editor software,
a user interface including a graphic display unit capable of showing visual media files processed with said editing software, and
the electronic device further comprising a computer program, the computer program comprising
a means for calculating a file size of a selected visual media record shown on the graphic display unit, which selected visual media record is processed with said media editor software, and
a means for showing said calculation result on the graphic display unit.

19. The electronic device according to claim 18 wherein said computer program further comprises a means for saving said visual media record after calculating its file size, if the file size is below a predetermined file size.

20. The electronic device according to claim 18 wherein the means for calculating the file size of the selected visual media record are arranged to make said calculation within said selection.

21. The electronic device according to claim 18 wherein the means for calculating the file size of the selected visual media record are arranged to make said calculation after said selection.

22. The electronic device according to claim 18 wherein means for calculating the file size of the selected visual media record are arranged to make said calculation after said visual media record is compressed.

23. The electronic device according to claim 22 wherein the compression method utilized is one of the following: GIF, TIFF or JPEG.

24. The electronic device according to claim 18 wherein the visual media record is picture file and editor software is imaging software.

25. The electronic device according to claim 24 wherein the imaging software is utilized in connection with a vCard application or a Presence application.

26. The electronic device according to claim 18 wherein the electronic device is a cellular terminal.
